(19) United States
(12) Patent Application Publication
(10) Pub. No.: US 2022/0160008 A1
(43) Pub. Date: May 26, 2022

(54) STEVIOL GLYCOSIDE COMPOSITIONS WITH IMPROVED SOLUBILITY

(71) Applicant: CORN PRODUCTS DEVELOPMENT, INC., Westchester, IL (US)

(72) Inventors: Akshay ANUGU, Bridgewater, NJ (US); Andrea BELFORD, Bridgewater, NJ (US); Kaitlin DIBLASIO, Bridgewater, NJ (US); Christopher GREGSON, Bridgewater, NJ (US); Kasi SUNDARESAN, Bridgewater, NJ (US); Kevin SYMCZAK, Bridgewater, NJ (US)

(21) Appl. No.: 17/433,074

(22) PCT Filed: Mar. 6, 2020
(86) PCT No.: PCT/US2020/021334

§ 371 Date: Aug. 23, 2021

Related U.S. Application Data
(60) Provisional application No. 62/814,734, filed on Mar. 6, 2019.

(51) Int. Cl. A23L 27/30; A23L 2/60

(52) U.S. Cl. CPC A23L 27/36; A23L 2/60

(57) ABSTRACT

Disclosed herein are steviol glycoside compositions containing steviol glycoside blends that synergistically increase the solubility of rebaudioside D and rebaudioside M. These new compositions have a clean taste and may be used as sweeteners or sweetness enhancers in reduced sugar foods and beverages. Also disclosed herein are methods for making and using these compositions.

This Application claims priority to U.S. Provisional Patent Application No. 62/814734, filed Mar. 6, 2019, which is incorporated herein in its entirety.

Disclosed herein are steviol glycoside compositions containing steviol glycoside blends that synergistically increase the solubility of rebaudioside D and rebaudioside M. These new compositions have a clean taste and may be used as sweeteners or sweetness enhancers in reduced sugar foods and beverages.

Steviol glycosides are a class of compounds that are capable of imparting a sweet taste to food and beverage products. These compounds are found in the leaves of Stevia rebaudiana (Bertoni), a perennial shrub that is native to certain regions of South America, e.g., Brazil and Paraguay, and they are characterized structurally by a common single base, steviol. Within the class of steviol glycoside molecules, species differ by the identity and number of carbohydrate residues at positions C13 and C19 of their base.

Researchers and food scientists are interested in steviol glycoside compounds because these compounds offer a potential solution to the problem of the increasing consumer demand for sweet foods and beverages that are non-caloric or are low caloric. However, these naturally occurring compounds cannot simply be substituted into products that contain glucose or other sugars. Among the challenges that one faces when using many steviol glycosides is the undesirable taste properties that they can impart, including one or more of a licorice taste, bitterness, astringency, sweet aftertaste, and bitter aftertaste.

Next generation steviol glycosides such as rebaudioside D (“Reb D”) and rebaudioside M (“Reb M”) offer better taste properties than the more commonly used steviol glycoside rebaudiosides, such as rebaudioside A (“Reb A”), offer. However, currently uses of Reb D and Reb M are limited due to their undesirably low solubilities.

The challenges of using Reb D and Reb M are particularly noticeable when one wishes to incorporate sweeteners that contain them into beverages. Beverage manufacturing processes often involve the production of an intermediate concentrated beverage syrup that is diluted with water to make a finished beverage. Typically, these processes require that the sweeteners that one uses stay dissolved in the concentrated beverage syrup for at least twenty-four hours. For example, many carbonated soft drink manufacturing processes involve the production of 5+1 throw syrup, which is then diluted with five times the volume of carbonated water to make a finished cola beverage. Additionally, because many beverages have a shelf life of from four weeks to one year, using a sweetener that has long term solubility is often desirable.

When used by itself and in common applications, Reb D has a water solubility of 350-400 ppm at 21° C. When Reb M is used by itself and in common applications, it has a water solubility of 1300-1500 ppm at 21° C. By contrast, when Reb A is used by itself and in common applications, it has a water solubility of 4000-8000 ppm at 21° C.

Unfortunately, many beverages require a higher amount of Reb D than its aforementioned solubility would allow in order to replace a desirable amount, if not all, of the sugar typically found in e.g., colas. Similarly, concentrated cola syrup requires a higher amount of Reb M than its aforementioned solubility would allow for producing low sugar and no-sugar added beverages.

Known methods for improving solubility include spray drying, heating to certain temperatures for certain amounts of time, co-crystallizing, adding a stabilizer, and adding a solubilizing enhancer. However, these methods can be cumbersome and ineffective when trying to incorporate Reb D and Reb M into products in sufficient amounts to impart a desired taste and to remain soluble for a sufficient amount of time.

Thus, there is a need to develop sweetener compositions in which Reb D and Reb M each have sufficiently high solubility that these steviol glycosides can perceptively, effectively, and satisfactorily contribute to the total sweetness of the target end product. The steviol glycoside compositions described herein address this need.

Disclosed herein are steviol glycoside compositions and methods for making and using these compositions. Various embodiments of the steviol glycoside compositions described herein provide a high solubility sweetener composition that contains Reb D and Reb M and that can be used to create food, beverage, and other products without undesirable taste characteristics.

One embodiment is directed to a dry blend of steviol glycosides comprising: (a) Reb A, wherein the Reb A is 35-80% by weight of the dry blend; (b) Reb D, wherein the Reb D is 4-8% by weight of the dry blend; and (c) Reb M, wherein the Reb M is 15-22% by weight of the dry blend, wherein the steviol glycosides of the dry blend have a combined water solubility of at least 10,000 ppm at 21° C. In another embodiment, these dry blends may be used in the preparation of a food product, a beverage product, or other products in which one finds sweeteners.

Another embodiment is directed to a method for producing a high solubility sweetener composition comprising dry blending a set of steviol glycosides, wherein the set of steviol glycosides comprises Reb A, Reb D, and Reb M to form a dry blend, wherein none of the steviol glycosides nor the dry blend have been co-processed, freeze-dried or co-spray dried, the Reb D is 4-8% by weight of the dry blend, the Reb M is 15-22% by weight of the dry blend and the Reb A is 40-75% by weight of the dry blend, and the steviol glycosides of the dry blend have a combined water solubility of at least 10,000 ppm at 21° C.

Through various embodiments described herein, one may produce and use dry blends of sweeteners that impart desirable levels of sweetness and have desirable water solubility. These dry blends may be used as sweeteners in many applications, including but not limited to food products, confections, condiments, baked goods, tabletop sweetener compositions, beverages, and beverage products.

### BRIEF DESCRIPTION OF THE FIGURE

FIG. 1 is a bar graph that shows the water solubility of each of four dry blends of the present invention and their components.

Reference will now be made in detail to various embodiments of the present invention, examples of which are illustrated in the accompanying figure. In the following description, numerous specific details are set forth in order to provide a thorough understanding of the present invention. However, unless otherwise indicated or implicit from context, the details are intended to be examples and should not be deemed to limit the scope of the invention in any way. Additionally, features described in connection with the various or specific embodiments are not to be construed as not appropriate for use in connection with other embodiments disclosed herein unless such exclusivity is explicitly stated or implicit from context.

### Dry Blends of Steviol Glycosides

One embodiment is directed to one or more dry blend of steviol glycosides. In one or more dry blend described herein, one or both of Reb D and Reb M have heightened solubility. The phrase “dry blend” as used herein refers to a physical mixture of substances and the dry blend may, in some embodiments, be created in the absence or essential absence of water or a solvent.

In some embodiments, one or more dry blend described herein contains a plurality of steviol glycosides. In some embodiments, one or more dry blend described herein comprises at least three steviol glycosides, at least four steviol glycosides, at least five steviol glycosides, or at least six steviol glycosides. In some embodiments, one or more dry blend described herein consists or consists essentially of steviol glycosides. In some embodiments, one or more dry blend described herein has 3-15 or 3-12 or 4-12 or 6-12 or 6-10 steviol glycosides.

In other embodiments, one or more dry blend described herein comprises: Reb D and Reb M; Reb D, Reb M, and Reb A; Reb D, Reb M, and stevioside; or Reb D, Reb M, Reb A, and stevioside. In still other embodiments, one or more dry blend described herein optionally further comprises at least one additional steviol glycoside.

In some embodiments, one or more dry blend described herein has a high solubility of Reb D and Reb M. In some embodiments, the solubility of the Reb D contained in one or more dry blend described herein is increased by at least 30%, at least 40%, or at least 50% above what the theoretic solubility would be were there no synergy in solubility as provided by the present invention. In other embodiments, the solubility of the Reb M contained in one or more dry blend described herein is increased by at least 20%, at least 25%, or at least 30% above what the theoretic solubility would be were there no synergy in solubility as provided by the present invention. Further, for one or more dry blend described herein, the overall solubility of the steviol glycoside components contained in such dry blend is increased by at least 20% or at least 25% above what the theoretic solubility would be were there no synergy in solubility as provided by the present invention. In these embodiments, the solubility may be measured in parts per million (ppm), which as persons of ordinary skill in the art will recognize may also be recited in the units of milligram (mg) per liter (L) of water. As used herein, the ppm standard is measured at 21 ° C.

In some embodiments, the steviol glycosides contained in one or more dry blend described herein has a combined water solubility of at least 10,000 ppm. The combined water solubility refers to the water solubility of all of the steviol glycosides such that there are at least 10,000 milligrams of steviol glycosides per liter of water. In some embodiments, the steviol glycosides contained in one or more dry blend described herein has a combined water solubility of 10,000 to 15,000 ppm or 10,000 to 12,000 ppm.

Additionally, in various embodiments describe herein, one or more dry blend described herein has long term solubility. As used herein, “long term solubility” refers to water solubility that endures for at least five days at the desired temperature, e.g., room temperate or about 21° C. As used herein “water solubility” means that when mixed with a solvent, e.g., water, the solution is clear (and thus not hazy), and one does not see particles. As persons of ordinary skill in the art are aware, solubility can be measured by any one or more standardized techniques, including but not limited to techniques that use HPLC.

In some embodiments, one or more dry blend described herein has a water solubility of at least 10,000 ppm, e.g., 10,000 to 15,000 ppm or 10,000 to 12,000 ppm, measured at 21 ° C., for at least five days, at least ten days, at least two weeks, at least four weeks, at least six months, or at least one year. Further, in some embodiments, one or more dry blend described herein has a water solubility of at least 10,000 ppm, e.g., 10,000 to 15,000 ppm or 10,000 to 12,000 ppm, measured at 21 ° C. for at least five days to at least two years or for at least five days to at least one year or for at least four weeks to at least one year or for at least six months to at least one year. Still further, in some embodiments, one or more dry blend described herein has a water solubility of at least 10,000 ppm, e.g., 10,000 to 15,000 ppm or 10,000 to 12,000 ppm, measured at 21 ° C. for five days to two years or for five days to one year or for four weeks to one year or six months to one year.

In some embodiments, one or more dry blend described herein contains 35-80 wt. % of Reb A or 40-75 wt. % of Reb A or 50-70 wt. % of Reb A or 55-65 wt. % of Reb A.

In some embodiments, one or more dry blend described herein contains 4-8 wt. % of Reb D or 5-7 wt. % of Reb D or 5-6 wt. % of Reb D. In some embodiments, the water solubility of the Reb D component of one or more dry blend described herein is at least 600 ppm or at least 700 ppm or at least 800 ppm when measured at 21° C. This solubility is measured as a component of the dry blend when the dry blend is dissolved in water.

In some embodiments, one or more dry blend described herein contains 15-22 wt. % of Reb M or 16-20 wt. % of Reb M or 16-18 wt. % of Reb M. In some embodiments, the water solubility of the Reb M component of one or more dry blend described herein is at least 2000 ppm or at least 2100 ppm or at least 2200 ppm when measured at 21° C. This is solubility measured as a component of the dry blend when the dry blend is dissolved in water.

In some embodiments of the one or more dry blend described herein, the weight ratio of Reb M to Reb D is from 2.5:1 to 4.5:1 or from 3:1 to 4:1 or from 3:1 to 3.5:1.

In some embodiments, one or more dry blend described herein contains 6-9 wt. % of stevioside, or 7-8 wt. % of stevioside. Stevioside may be present in addition to or instead of Reb A.

In some embodiments, the combined weight percentage of Reb A, Reb D, and Reb M contained in the one or more dry blend described herein is at least 50 wt. % of the dry blend, at least 55 wt. % of the dry blend, at least 60 wt. % of the dry blend, at least 65 wt. % of the dry blend, at least 70 wt. % of the dry blend, at least 75 wt. % of the dry blend, at least 80 wt. % of the dry blend, at least 85 wt. % of the dry blend, at least 90 wt. % of the dry blend, at least 95 wt. % of the dry blend, at least 98 wt. % of the dry blend, or at least 99 wt. % of the dry blend. In some embodiments, the combined weight percentage of Reb A, Reb D, Reb M, and stevioside contained in the one or more dry blend described herein is at least 50 wt. % of the dry blend, at least 55 wt. % of the dry blend, at least 60 wt. % of the dry blend, at least 65 wt. % of the dry blend, at least 70 wt. % of the dry blend, at least 75 wt. % of the dry blend, at least 80 wt. % of the dry blend, at least 85 wt. % of the dry blend, at least 90 wt. % of the dry blend, at least 95 wt. % of the dry blend, at least 98 wt. % of the dry blend, or at least 99 wt. % of the dry blend.

In one embodiment, one or more dry blend described herein comprises 40-75 wt. % Reb A, 4-8 wt. % Reb D, and 15-22 wt. % Reb M. In another embodiment, t one or more dry blend described herein comprises 55-65 wt. % Reb A, 5-6 wt. % Reb D, and 16-18 wt. % Reb M. In either of these embodiments, the dry blend may also further comprise stevioside.

In other embodiments, one or more dry blend described herein may also further contain one or more additional steviol glycosides. In other embodiments, the one or more additional steviol glycoside is selected from rebaudioside B (“Reb B”), rebaudioside C (“Reb C”), rebaudioside D4 (“Reb D4”), rebaudioside E (“Reb E”), rebaudioside F (“Reb F”), rebaudioside G (“Reb G”), rebaudioside H (“Reb H”), rebaudioside I (“Reb I”), rebaudioside J (“Reb J”), rebaudioside K (“Reb K”), rebaudioside L (“Reb L”), rebaudioside M2 (“Reb M2”), rebaudioside N (“Reb N”), rebaudioside 0 (“Reb O”), rebaudioside S (“Reb S”), rebaudioside T (“Reb T”), rebaudioside U (“Reb U”), rebaudioside V (“Reb V”), rebaudioside W (“Reb W”), rebaudioside Z1 (“Reb Z1”), rebaudioside Z2 (“Reb Z2”), steviolmonoside, steviolbioside, rubusoside, dulcoside A, dulcoside B, enzymatically glucosylated steviol glycosides, and combinations thereof. In another embodiment, the additional steviol glycosides are selected from: stevioside, Reb B, Reb C, Reb F, dulcoside A, rubusoside, steviolbioside, and combinations thereof.

In some embodiments, each additional steviol glycoside or all steviol glycosides combined are present in limited amounts, e.g., less than 5 wt. %, less than 4 wt. %, less than 3 wt. %, less than 2 wt. %, less than 1 wt. %, less than 0.5 wt. %, or less than 0.1 wt. %. By way of non-limiting examples, the dry blends of the present invention may contain Reb B in an amount that is less than 5 wt. %, less than 4 wt. %, less than 3 wt. %, less than 2 wt. %, less than 1 wt. %, less than 0.5 wt. %, or less than 0.1 wt. % of the weight of the dry blend. Additionally, or alternatively, the dry blends of the present invention may contain Reb C in an amount that is less than 5 wt. %, less than 4 wt. %, less than 3 wt. %, less than 2 wt. %, less than 1 wt. %, less than 0.5 wt. %, or less than 0.1 wt. % of the weight of the dry blend.

Further, in some embodiments, the dry blends contain an absence or essentially absence (e.g., 0-0.05 wt. % or 0-0.01 wt. %) of one or more of the additional steviol glycosides recited above. By way of a non-limiting example, in some embodiments, the present invention contains an essential absence of one or more or all of Reb B, Reb C, Reb E, Reb F, Reb G, Reb H, Reb I, Reb J, Reb K, Reb L, Reb M2, Reb N, Reb S, Reb T, Reb U, Reb V, Reb W, Reb Z1, and Reb Z2. In one embodiment, the dry blend contains an essential absence of Reb E, Reb N, and Reb O.

Additionally, in some embodiments, the dry blend contains an essential absence of non-steviol glycoside sweeteners. “Non-steviol glycoside sweeteners” are compounds and compositions that can impart sweetness but are not within the class of compounds of steviol glycosides

### Methods of Creating a Dry Blend

As persons of ordinary skill in the art are aware, dry blending refers to mechanically mixing a plurality of substances to form a product that is referred to as a dry blend. Methods for creating dry blends are well-known to persons of ordinary skill in the art and include, but are not limited to, using a conventional paddle blender, a ribbon blender, or a twin-shell V blender for a sufficient amount of time to mix the components, e.g., ten minutes to two hours or fifteen minutes to one hour at e.g., 50-200 rpm or 50-100 rpm. Optionally, one can premix the components and/or load them into the mixers by layers. Various methods of the present invention comprise, consist essentially of, consist of, or are characterized by the dry blending of the ingredients of the present invention.

In some embodiments, no additional step is used for or when combining the steviol glycosides or forming the dry blend. Thus, for example there may be no co-processing, freeze-drying, or co-spraying of the components individually or as part of a mixture. Additionally, in some embodiments, the dry blend is formed without the addition of heat and/or without water or a solvent.

### Uses of Dry Blends

The dry blends of the present invention may be used in diverse applications, including but not limited to being incorporated into food products and beverage products. Among the advantages of the dry blends of the present invention is that they may easily be incorporated into known processes for making foods, beverages, and other products without any additional processing steps. In some embodiments, when incorporated into the beverages, foods, or other products, the components of the dry blend remain soluble for at least four weeks or at least six months or at least a year or from at least four weeks to year or at least four weeks to six months, or four weeks to a year or four weeks to six months.

Examples of food products include, but are not limited to, confections, condiments, chewing gum, frozen foods, canned foods, soy-based products, salad dressings, mayonnaise, vinegar, ice cream, cereal compositions, baked goods, dairy products such as yogurts, and tabletop sweetener compositions. Examples of beverages include, but are not limited to, ready-to-drink products that are carbonated (e.g., colas or other soft drinks, sparkling beverages, and malts) or non-carbonated (e.g., fruit juices, nectars, vegetable juices, sports drinks, energy drinks, enhanced water, coconut waters teas, coffees, cocoa drinks, beverages containing milk, beverages containing cereal extracts, smoothies, and alcoholic beverages), as well as powdered beverage products that are to be combined with a liquid base such as water, milk, or club soda and beverage concentrates such as throw syrups, e.g., 5+1 and 9+1 throw syrups. The dry blends of the present invention may also be used in dental compositions and pharmaceutical compositions.

In some embodiments, the dry blends of the present invention may be mixed with a solvent at room temperature before or when being combined with other ingredients of food, beverage, or other products. In other embodiments, a gradient heat treatment may be employed.

When incorporated into food, beverage, or other products, the dry blends of the present invention may be the sole sweetening component or other sweeteners may also be incorporated into the product. For example, the dry blend may be combined with at least one additional sweetener, such as a carbohydrate sweetener. Examples of carbohydrate sweeteners include, but are not limited to, sucrose, fructose, glucose, erythritol, maltitol, lactitol, sorbitol, mannitol, xylitol, D-psicose, D-tagatose, leucrose, trehalose, galactose, rhamnose, cyclodextrin (e.g., a-cyclodextrin, P-cyclodextrin, and y-cyclodextrin), ribulose, threose, arabinose, xylose, lyxose, allose, altrose, mannose, idose, lactose, maltose, invert sugar, isotrehalose, neotrehalose, palatinose or isomaltulose, erythrose, deoxyribose, gulose, idose, talose, erythrulose, xylulose, psicose, turanose, cellobiose, glucosamine, mannosamine, fucose, fuculose, glucuronic acid, gluconic acid, glucono-lactone, abequose, galactosamine, xylo-oligosaccharides (xylotriose, xylobiose and the like), gentio-oligoscaccharides (gentiobiose, gentiotriose, gentiotetraose and the like), galacto-oligosaccharides, sorbose, ketotriose (dehydroxyacetone), aldotriose (glyceraldehyde), nigero-oligosaccharides, fructooligosaccharides (kestose, nystose and the like), maltotetraose, maltotriol, tetrasaccharides, mannan-oligosaccharides, malto-oligosaccharides (maltotriose, maltotetraose, maltopentaose, maltohexaose, maltoheptaose and the like), dextrine, lactulose, melibiose, rhamnose, ribose, isomerized liquid sugars such as high fructose corn/starch syrup (HFCS/HFSS) (e.g., HFCS55, HFCS42, or HFCS90), coupling sugars, soybean oligosaccharides, glucose syrup and combinations thereof.

Other additional sweeteners include but are not limited to high potency sweeteners such as mogroside IV, mogroside V, mogroside VI, iso-mogroside V, grosmomoside, neomogroside, siamenoside, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, and cyclocarioside I.

The dry blends of the present invention may also be combined with one or more additives that may or may not also be additional sweeteners. Examples of additives include but are not limited to carbohydrates, polyols, amino acids and their corresponding salts, sugar acids and their corresponding salts, nucleotides, organic acids, inorganic acids, organic salts, including organic acid salts and organic base salts, inorganic salts, bitter compounds, flavorants and flavoring ingredients, astringent compounds, proteins or protein hydrolysates, emulsifiers, weighing agents, gums, colorants, flavonoids, alcohols, polymers, essential oils, anti-fungal agents and combinations thereof.

The dry blends of the present invention may also be combined with one or more bulking agents that may also qualify as additives or additional sweeteners. Bulking agents may, for example, be used to facilitate a direct substitution of the dry blend sweetener of the present invention for sugar in applications such as baking, cooking, and tabletop uses. Examples of bulking agents include but are not limited to: a bulk sweetener such as sucrose, dextrose, invert sugar maltose, dextrin, maltodextrin, fructose, levulose, and galactose; a low glycemic carbohydrate such as fructo-oligosaccharides, galacto-oligosaccharides, mannitol, xylitol, lactitol, erythritol, and malitol; a fiber, such as polydextrose, resistant maltodextrin, resistant starch, soluble corn fiber, and cellulose; and a hydrocolloid, such as pectin, guar gum, carboxymethylcellulose, locust bean gum, cassia gum, and alginate.

The dry blends of the present invention may also be combined with one or more functional ingredients. Examples of functional ingredients include but are not limited to antioxidants, dietary fiber sources, fatty acids, vitamins, glucosamine, minerals, medicines, and preservatives.

Subject matter contemplated by the present disclosure is set out in the following numbered embodiments:
1. A dry blend of steviol glycosides comprising:

(a) Reb A, wherein the Reb A is 35-80% by weight of the dry blend;

(b) Reb D, wherein the Reb D is 4-8% by weight of the dry blend; and

(c) Reb M, wherein the Reb M is 15-22% by weight of the dry blend,

wherein the steviol glycosides of the dry blend have a combined water solubility of at least 10,000 ppm at 21° C.
2. The dry blend of embodiment 1, wherein the combined water solubility is for at least five days.
3. The dry blend of embodiment 1 or embodiment 2, further comprising stevioside, wherein the stevioside is 6-9% by weight of the dry blend.
4. The dry blend of any of embodiments 1 to 3, wherein:

(a) the Reb A is 55-65% by weight of the dry blend;

(b) the Reb D is 5-6% by weight of the dry blend; and

(c) the Reb M is 16-18% by weight of the dry blend.
5. The dry blend of any of embodiments 1 to 4, wherein the combined weight percentage of Reb A, Reb D, and Reb M is at least 85% or at least 95%.
6. The dry blend of any of embodiments 1 to 5, further comprising at least one additional steviol glycoside.
7. The dry blend of embodiment 6, wherein the at least one additional steviol glycoside is selected from Reb B, Reb C, Reb D4, Reb E, Reb F, Reb G, Reb H, Reb I, Reb J, Reb K, Reb L, Reb M2, Reb N, Reb O, Reb S, Reb T, Reb U, Reb V, Reb W, Reb Z1, Reb Z2, steviolmonoside, steviolbioside, rubusoside, dulcoside A, dulcoside B, enzymatically glucosylated steviol glycosides, and combinations thereof.
8. The dry blend of embodiment 6 or embodiment 7, wherein the at least one additional steviol glycoside is present in an amount of less than 5% by weight of the dry blend.
9. The dry blend of any of embodiments 6 to 8, wherein the at least one steviol glycoside is Reb B and the Reb B is present in an amount of less than 5% by weight of the dry blend or less than 2% by weight of the dry blend.
10. The dry blend of any of embodiments 6 to 9, wherein the at least one steviol glycoside is Reb C, wherein the Reb C is present in an amount of less than 5% by weight of the dry blend or less than 2% by weight of the dry blend.
11. The dry blend of any of embodiments 6 to 10, wherein the at least one steviol glycoside is Reb F, wherein the Reb F is present in an amount of less than 5% by weight of the dry blend or less than 2% by weight of the dry blend.
12. The dry blend of any of embodiments 6 to 11, wherein the at least one steviol glycoside comprises the combination of at least two of Reb B, Reb C, and Reb F.
13. The dry blend of embodiment 12, wherein the at least one steviol glycoside comprises the combination of all three of Reb B, Reb C, and Reb F.
14. The dry blend of any of embodiments 1 to 13, wherein the weight ratio of Reb M to Reb D is from 2.5:1 to 4.5:1, preferably 3:1 to 4:1.
15. The dry blend of any of embodiments 1 to 14, wherein the water solubility of Reb D within the dry blend is at least 600 ppm at 21° C.
16. The dry blend of any of embodiments 1 to 15, wherein the water solubility of Reb M within the dry blend is at least 2000 ppm at 21° C.
17. The dry blend of any of embodiments 1 to 16, wherein there is an essential absence of non-steviol glycoside sweeteners.
18. A beverage comprising the dry blend of any of embodiments 1 to 17.
19. The beverage of embodiment 18, wherein the dry blend remains soluble in the beverage for at least four weeks, preferably at least one year.
20. A beverage concentrate comprising the dry blend of any of embodiments 1 to 17.
21. The beverage concentrate of embodiment 20, wherein said beverage concentrate is a throw syrup.
22. Use of a dry blend of any of embodiments 1 to 21 for the preparation of a food product or a beverage product.
23. A method for producing a high solubility sweetener composition comprising dry blending a set of steviol glycosides, wherein the set of steviol glycosides comprises Reb A, Reb D, and Reb M to form a dry blend, wherein none of the steviol glycosides nor the dry blend have been co-processed, freeze-dried or co-spray dried, the Reb D is 4-8% by weight of the dry blend, the Reb M is 15-22% by weight of the dry blend and the Reb A is 40-75% by weight of the dry blend, and the steviol glycosides of the dry blend have a combined water solubility of at least 10,000 ppm at 21° C.

### EXAMPLES

### Example 1

### Solubility Testing Methodology

Double column systems were used to determine the predictive versus actual concentration of comparative steviol glycoside formulations. Dry blend analyses (in this and all subsequent examples) were conducted using high-performance liquid chromatography, a variable wavelength detector @ 210 nm, and two columns in tandem, both of which were 250 mm×4.6 mm Phenomenex Synergi 4 μm Hydro-RP 80 Å.

Measurements were taken weekly for a period of two weeks. Table I shows both the measured total solubility of steviol glycosides and the theoretical solubility.

TABLE I
Solubility Comparison Products

| | Total | Theoretical |
|---|---|---|
| Comparison Product | Solubility (ppm) | Solubility (ppm) |
| A | 3341 | 3777 |
| B | 730 | 675 |
| C | 912 | 858 |

Comparison Product A contains 56% Reb A and 40% Reb M.

Comparison Product B contains 37% Reb A and 60% Reb D.

Comparison Product C contains 28% Reb A, 45 Reb D, and 24% Reb M.

This table shows that the testing methods for solubility that were employed are consistent with the predicted theoretical solubility, and that in these compositions high purity ingredients are additive in terms of solubility.

### Example 2

### Solubility of Dry Blend 1

A dry blend comprising Reb A, Reb D, and Reb M was created. Measurements of solubility were taken, and the percentage of the dry blend (DB 1) components and their solubilities are reported in Table II.

TABLE II
Composition Dry Blend 1 Products

| Component | % of Dry Blend | PPM at Equilibrium |
|---|---|---|
| Reb A | 60.9 | 7162 |
| Reb D | 5.3 | 639 |
| Reb M | 16.3 | 1959 |
| Other | 17.5 | 2070 |
| Total | 100% | 11,830 |

The normalized percentages of Reb A, Reb D, and Reb M were 73.8%, 6.4% and 19.8%, respectively. The solubility of DB 1 is significantly higher than the solubility of the products identified in Table I.

### Example 3

### Solubility of Dry Blends 2-4

Empirical solubility measurements of three dry blends according to the present invention were taken and are shown in Table III with a comparison to the theoretical solubility.

TABLE III
Solubility Dry Blend 2-4 Products

| | Total | Theoretical |
|---|---|---|
| Dry Blend Product | Solubility (ppm) | Solubility (ppm) |
| DB 2 | 10404 | 8332 |
| DB 3 | 10063 | 8332 |
| DB 4 | 10360 | 8332 |

Table IV shows the composition of DB 2.

TABLE IV
Composition Dry Blend 2

| Component | % of dry blend | PPM at Equilibrium |
|---|---|---|
| Reb A | 61.8 | 6225 |
| Reb D | 5.7 | 616 |
| Reb M | 16.7 | 1910 |
| Other | 15.8 | 1653 |
| Total | 100% | 10404 |

Table V shows the composition of DB 3.

TABLE V
Composition of Dry Blend 3

| Component | % Dry Blend | PPM at Equilibrium |
|---|---|---|
| Reb A | 61.3 | 6051 |
| Reb D | 5.5 | 599 |
| Reb M | 17.6 | 1843 |
| Other | 15.6 | 1570 |
| Total | 100% | 10063 |

Table VI shows the composition of DB 4.

TABLE VI
Composition of Dry Blend 4

| Component | % Dry Blend | PPM at Equilibrium |
|---|---|---|
| Reb A | 61.3 | 6173 |
| Reb D | 5.5 | 617 |
| Reb M | 16.3 | 1806 |
| Other | 17.0 | 1764 |
| Total | 100% | 10360 |

### Example 4

### Solubility of Dry Blends 5-10

Table VII contains Reb A, Reb D, Reb M wt. % for dry blends 5 -10 and the observed system solubilities for all steviol glucosides.

TABLE VII
Solubility Dry Blends 5-10

| | | | | Total |
|---|---|---|---|---|
| Dry Blend | Reb A % | Reb D % | Reb M % | solubility (ppm) |
| DB 5 | 60.51 | 5.4 | 16.55 | 11837 |
| DB 6 | 43.67 | 5.96 | 18.84 | 10701 |
| DB 7 | 50.78 | 5.45 | 19.42 | 10658 |
| DB 8 | 70.30 | 5.68 | 19.82 | 10362 |
| DB 9 | 40.61 | 5.90 | 18.72 | 10811 |
| DB 10 | 58.98 | 5.84 | 18.10 | 10554 |

The data in Table VII show the consistency of the increased solubility of dry blends of the present invention.

### Example 5

### Absence Effect of Other Steviol Glycosides

Four dry blends of the present invention were tested for water solubility. In these dry blends, the amount of each of the components other than Reb A, Reb D, and Reb M were varied. Table VIII shows that an increase in the other components did not affect solubility.

TABLE VIII
Impact of Other Components on Solubility

| Dry | % of Other | Total Solubility | Theoretical |
|---|---|---|---|
| Blend | Components | (ppm) | Solubility (ppm) |
| DB 11 | 3.74 | 10313 | 8390 |
| DB 12 | 24.0 | 10605 | 8459 |
| DB 13 | 30.5 | 10550 | 8509 |
| DB 14 | 35.1 | 10861 | 8510 |

Table IX shows the composition of DB 11.

TABLE IX
Composition of Dry Blend 11

| Component | % Dry Blend | PPM at Equilibrium |
|---|---|---|
| Reb A | 73.4 | 7284 |
| Reb D | 5.1 | 589 |
| Reb M | 17.8 | 2054 |
| Other | 3.74 | 386 |
| Total | 100% | 10313 |

Table X shows the composition of DB 12.

TABLE X
Composition of Dry Blend 12

| Component | % of Dry Blend | PPM at Equilibrium |
|---|---|---|
| Reb A | 53.6 | 5412 |
| Reb D | 5.0 | 581 |
| Reb M | 17.4 | 2070 |
| Other | 24 | 2542 |
| Total | 100% | 10605 |

Table XI shows the composition of DB 13.

TABLE XI
Composition of Dry Blend 13

| Component | % of Dry Blend | PPM at Equilibrium |
|---|---|---|
| Reb A | 44.5 | 4673 |
| Reb D | 5.2 | 638 |
| Reb M | 19.8 | 2016 |
| Other | 30.5 | 3223 |
| Total | 100% | 10550 |

Table XII shows the composition of DB 14.

TABLE XII
Composition of Dry Blend 14

| Component | % of Dry Blend | PPM at Equilibrium |
|---|---|---|
| Reb A | 42.3 | 4390 |
| Reb D | 5.9 | 638 |
| Reb M | 16.7 | 2024 |
| Other | 35.1 | 3809 |
| Total | 100% | 10861 |

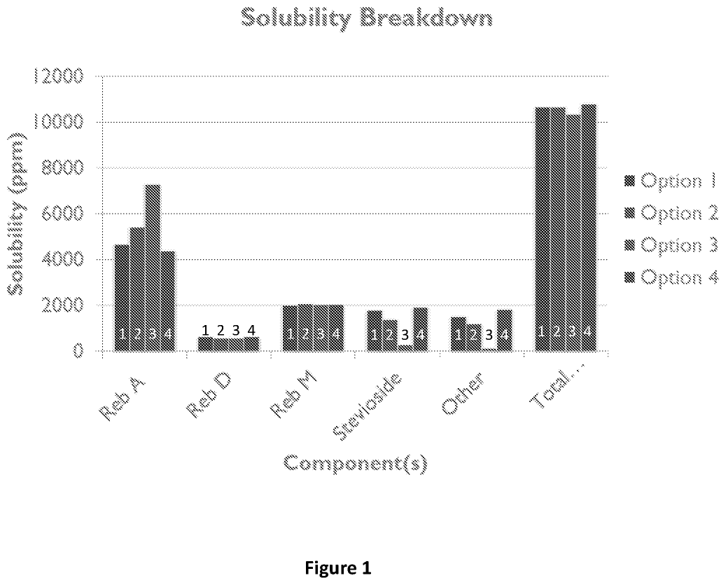

FIG. 1 shows a comparison of the components of data contained in Tables VIII to XII. All of the total solubilities are greater than 10,000 ppm. Additionally, the variation in amount of stevioside, Reb A and other steviol glycosides did not decrease solubility below 10,000 ppm.

1. A dry blend of steviol glycosides comprising:
(a) Reb A, wherein the Reb A is 35-80% by weight of the dry blend;
(b) Reb D, wherein the Reb D is 4-8% by weight of the dry blend;
(c) Reb M, wherein the Reb M is 15-22% by weight of the dry blend: and
(d) Optionally, at least one additional steviol glycoside,
wherein the steviol glycosides of the dry blend have a combined water solubility of at least 10,000 ppm at 21° C. for, optionally, at least 5 days.

2. (canceled)

3. The dry blend of claim 1, further comprising stevioside, wherein the stevioside is 6-9% by weight of the dry blend.

4. The dry blend of claim 1, wherein:
(a) the Reb A is 55-65% by weight of the dry blend;
(b) the Reb D is 5-6% by weight of the dry blend; and
(c) the Reb M is 16-18% by weight of the dry blend.

5. The dry blend of claim 1, wherein the combined weight percentage of Reb A, Reb D, and Reb M is at least 85% or at least 95%.

6. (canceled)

7. The dry blend of claim 1, wherein the dry blend comprises at least one additional steviol glycoside, and said additional steviol glycoside is selected from Reb B, Reb C, Reb D4, Reb E, Reb F, Reb G, Reb H, Reb I, Reb J, Reb K, Reb L, Reb M2, Reb N, Reb O, Reb S, Reb T, Reb U, Reb V, Reb W, Reb Z1, Reb Z2, steviolmonoside, steviolbioside, rubusoside, dulcoside A, dulcoside B, enzymatically glucosylated steviol glycosides, and combinations thereof.

8. The dry blend of claim 7, wherein the at least one additional steviol glycoside is present in an amount of less than 5% by weight of the dry blend.

9. The dry blend of claim 7, wherein the at least one additional steviol glycoside is Reb B and the Reb B is present in an amount of less than 5% by weight of the dry blend or less than 2% by weight of the dry blend.

10. The dry blend of claim 7, wherein the at least one additional steviol glycoside is Reb C, wherein the Reb C is present in an amount of less than 5% by weight of the dry blend or less than 2% by weight of the dry blend.

11. The dry blend of claim 7, wherein the at least one additional steviol glycoside is Reb F, wherein the Reb F is present in an amount of less than 5% by weight of the dry blend or less than 2% by weight of the dry blend.

12. The dry blend of claim 7, wherein the at least one additional steviol glycoside comprises the combination of at least two of Reb B, Reb C, and Reb F or all three of Reb B, Reb C, and Reb F .

13. (canceled)

14. The dry blend of any of claim 1, wherein the weight ratio of Reb M to Reb D is from 2.5:1 to 4.5:1 or 3:1 to 4:1.

15. The dry blend of claim 1, wherein the water solubility of Reb D within the dry blend is at least 600 ppm at 21° C.

16. The dry blend of claim 1, wherein the water solubility of Reb M within the dry blend is at least 2000 ppm at 21° C.

17. The dry blend of claim 1, wherein there is an essential absence of non-steviol glycoside sweeteners.

18. A beverage comprising the dry blend of claim 1.

19. The beverage of claim 18, wherein the dry blend remains soluble in the beverage for at least four weeks or , at least one year.

20. A beverage concentrate comprising the dry blend of claim 1.

21. The beverage concentrate of claim 20, wherein said beverage concentrate is a throw syrup.

22. (canceled)

23. A method for producing a high solubility sweetener composition comprising dry blending a set of steviol glycosides, wherein the set of steviol glycosides comprises Reb A, Reb D, and Reb M to form a dry blend, wherein none of the steviol glycosides nor the dry blend have been co-processed, freeze-dried or co-spray dried, the Reb D is 4-8% by weight of the dry blend, the Reb M is 15-22% by weight of the dry blend and the Reb A is 40-75% by weight of the dry blend, and the steviol glycosides of the dry blend have a combined water solubility of at least 10,000 ppm at 21° C.
